(19) United States
(12) Patent Application Publication
(10) Pub. No.: US 2007/0239465 A1
(43) Pub. Date: Oct. 11, 2007

(54) METHOD AND SYSTEM FOR AUTOMATICALLY RENTING BICYCLES

(75) Inventor: Jacques Le Gars, GAMBAIS (FR)

Correspondence Address: MILLER, MATTHIAS & HULL, ONE NORTH FRANKLIN STREET, SUITE 2350, CHICAGO, IL, 60606, US

(73) Assignee: JC DECAUX SA, NEUILLY SUR SEINE (FR)

(21) Appl. No.: 10/596,094

(22) PCT Filed: Nov. 29, 2004
(86) PCT No.: PCT/FR04/03057

§ 371 Date: May 30, 2006

(30) Foreign Application Priority Data
Dec. 1, 2003 (FR) 0314066

(51) Int. Cl. G06Q 10/00; G06Q 30/00

(52) U.S. Cl. 705/1

(57) ABSTRACT

The invention relates to a method for automatically renting bicycles (1) during which an authorization of a deduction of a certain maximum value from an account associated with a payment card is firstly generated, this authorization being valid for a limited period of time. Upon each subsequent rental of an article, a user furnishes an identification code associated with the authorization identifier, the identification code furnished by the user is verified whether it corresponds to the authorization identifier, and a rental of the article is authorized or not authorized on the basis of this verification. Finally, after a certain period of time, an amount based on the effected rentals is debited from the account associated with the payment card.

The present invention relates to automatic methods and systems for automatically renting bicycles.

Methods are known for automatically renting articles such as video cassettes or the like, such as, for example, the method described in Document EP-A-0 287 367. Unfortunately, methods of that type cannot be applied to automatically renting bicycles in urban environments, where there must be multiple places for users to take and to return bicycles.

A particular object of the present invention is to provide an automatic bicycle rental method that makes it possible for a payment card to be used for paying for the rental, and that makes it possible for there to be multiple places where users can take and return bicycles.

To this end, the invention provides a method of automatically renting bicycles by means of interactive terminal posts which communicate remotely with at least one rental management server, and each of which controls a plurality of locking stations (9) to which the bicycles are locked, said method comprising the following steps:

(a) an initial step consisting in:

reading a payment card;

communicating with an electronic money server for generating a debit authorization for debiting a certain maximum value from an account associated with the payment card, this authorization being valid for a limited period;

allocating an authorization identifier to said authorization; and

storing the authorization identifier in the rental management server;

(b) at least one subsequent rental step taking place during said limited period and consisting in:

a user who wishes to rent a bicycle indicating at least one identity code associated with said authorization identifier;

the rental management server being used to verify that the identity code indicated by the user corresponds to said authorization identifier stored in said rental management server; and

the bicycle rental being authorized or not authorized as a function of said verification; and

(c) a debit step consisting in communicating with the electronic money server for debiting said account associated with the payment card for an amount that is a function of the rental operations effected, inclusively from said initial step, said amount being no more than said maximum value.

By means of these provisions, and since the method of the invention uses at least one rental management server that communicates with a plurality of interactive rental terminal posts and that centralizes, in particular, the authorization identifier allocated to a user who wishes to rent bicycles, the user can rent a bicycle from any interactive terminal post connected to the rental management server.

In addition, the user can effect subsequent rental operations using his or her ticket as frequently as necessary, without having to use his or her payment card, and thus without any risk of losing it, In addition, once the user has obtained the ticket, said user can, without any risk, give the ticket to another person, in particular to a person who does not have a payment card (e.g. a child) in order to enable that person to access the rental services.

It should be noted that, during each subsequent rental step, the identity code indicated by the user can, for example be input on an input interface such as a keypad, a touch-sensitive screen, or a voice recognition system, or it can be read automatically from an information medium (such as, for example, a ticket or the like) fed into a reader device by the user, or communicated automatically by using an item of equipment bearing an identity code, e.g. a mobile phone or “cellphone” (the subscriber number can then serve as an identity code for the item of equipment).

In addition, the identity code indicated by the user can be either the authorization identifier itself, or another identity code that can be associated with said identifier, e.g. by a article rental management server. In a variant, the user can also be required to indicate a plurality of identity codes, including, for example:

a first identity code indicated automatically by reading an information medium or by using an item of electronic equipment bearing said first identity code; and

a confidential second identity code.

In various implementations of the method of the invention, it is optionally possible to use one or more of the following provisions:

during the initial step, the identity code is communicated to a user and, during each subsequent rental step, the identity code is input by said user on an input interface;

during the initial step, the identity code is written on an information medium, and, during each subsequent rental step, the identity code is read automatically from said information medium;

during the initial step, a ticket bearing said identity code and constituting said information medium is issued;

during the initial step, the identity code is recorded on a magnetic stripe carried by said ticket;

the code borne by the ticket is written at least in part during the initial step, after the debit authorization;

the code written on the ticket includes the authorization identifier generated during the initial step;

the code written on the ticket is pre-written at least in part prior to the initial step, and, during said initial step, a correspondence between the code written on the ticket and the identifier determined during the debit authorization is stored in a memory;

the code written on the ticket comprises a pre-written portion written before the initial step and a portion written during said initial step;

during the initial step, a payment card of predetermined format is used, and the ticket presents said predetermined format;

the payment card presents a magnetic stripe having a predetermined position, the ticket also presents a magnetic stripe having the same position, and the identity code is written on the magnetic stripe of said ticket;

during the initial step, a code borne by a mobile phone is recorded as the identity code, and, during each subsequent rental step, the user calls a predetermined number, the calling telephone number is determined, and the authorization identifier corresponding to said identity code is thus determined;

during each subsequent rental step, when the bicycle is returned to a locking station, said bicycle is locked again to said locking station;

the debit step is implemented at a time that is predetermined relative to the initial step;

the debit step is implemented when the cumulative cost of the rental operations that have taken place during said limited period reaches a certain predetermined amount that is no more than said maximum value;

the initial step includes an initial rental step during which, after the debit authorization, at least one bicycle that is locked to a locking station is released, and then, when the bicycle is returned to a locking station, said bicycle is locked to said locking station again;

each time a rental operation takes place, the value of a sum owed by the user of the payment card is incremented;

each bicycle is identified at least when it is taken out and when it is returned, and when a bicycle taken out is not identified as a bicycle returned at the end of a certain predetermined time limit, the debit step is preformed immediately, and a deposit is debited from said account;

during the initial step, a confidential code is determined, and, during each subsequent rental step, the rental is authorized only after verifying that the confidential code is known by the user requesting the rental;

provision is made for the confidential code to be chosen by the user during the initial step;

during the debit step, the rental management server communicates the authorization identifier and the owed sum to the electronic money server; and

during the initial step, an address given by the user is stored in a memory, and communication is established with the user via said address if a bicycle taken out using the identity code of said user is not returned within a predetermined time limit.

In addition, the invention further provides a system for implementing a method as defined above, said system comprising:

interactive terminal posts which communicate remotely with at least one rental management server, and each of which controls a plurality of locking stations to which the bicycles are locked;

means for reading a payment card;

means for communicating with an electronic money server for obtaining a debit authorization for debiting a certain maximum value from an account associated with the payment card, said authorization being valid for a limited period, and said authorization being identified by an authorization identifier;

means for storing said authorization identifier in the rental management server;

means for acting by communicating with the rental management server to determine whether an identity code indicated by a user corresponds to said authorization identifier, so a to authorize or not authorize the desired rental of a bicycle as a function of said verification; and

means for communicating with the electronic money server for debiting an amount that is a function of the rental operations effected from the account associated with the payment card.

Other characteristics and advantages of the invention appear from the following description of an implementation thereof, given by way of non-limiting example, and with reference to the accompanying drawings.

In the drawings:

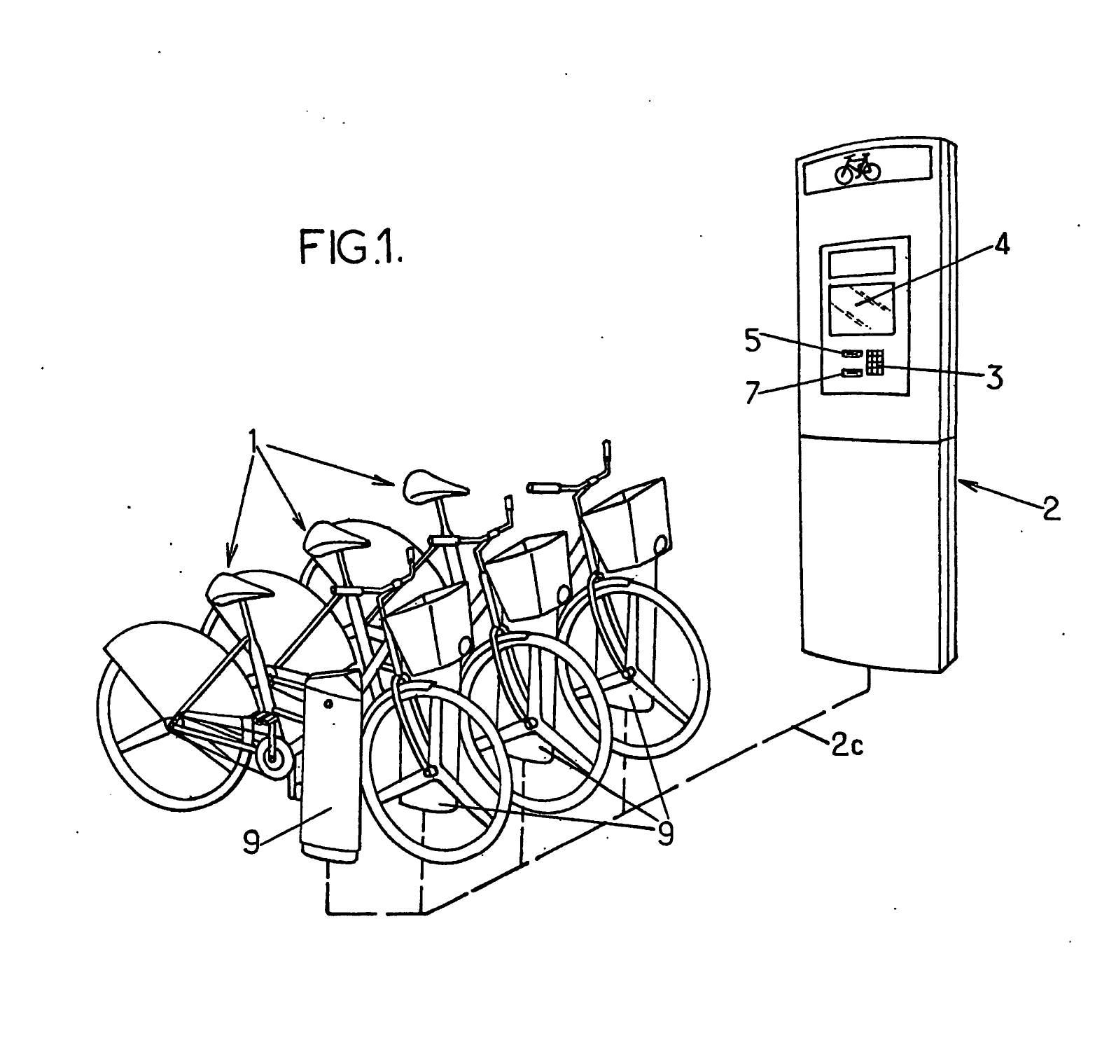

FIG. 1 is a diagrammatic perspective view showing a portion of an embodiment of an automatic bicycle rental system of the invention;

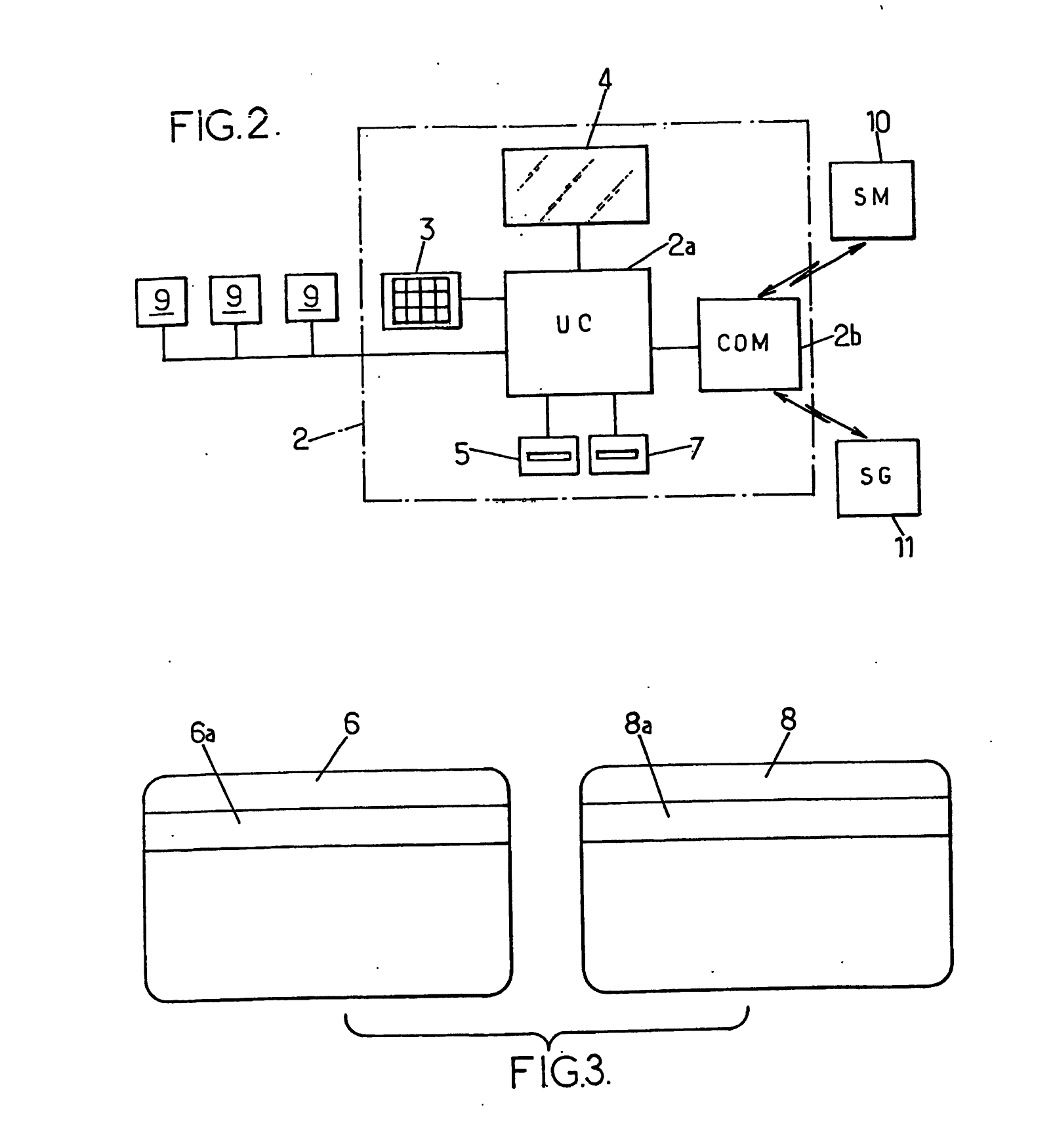

FIG. 2 is a block diagram of the system of FIG. 1; and

FIG. 3 is a detail view showing a payment card and a ticket that can be used in the system of FIGS. 1 and 2.

In the various figures, like references designate elements that are identical or similar.

As shown in FIGS. 1 and 2, the present invention relates to a system for automatically renting articles, e.g. cycles 1 such as, in particular, bicycles, making it possible, for example, to store the cycles on a public thoroughfare so as to make them available to the public.

The automatic cycle rental system can, for example, include an interactive terminal post 2 or the like provided with a central processing unit (CPU) 2a (UC), e.g. a microcomputer CPU, which can be connected, in particular, to:

a communications device 2b (COM), e.g. a radio-communications device;

a keypad 3 or some other data input interface;

a screen 4;

a card reader 5 for reading electronic payment cards such as the card 6 shown in FIG. 3; and

a printer 7 for printing tickets on thin card such as the ticket 8 also shown in FIG. 3,

The interactive terminal post 2 is connected, e.g. via an underground wire link 2c, to a plurality of lock stations 9 that can, for example, be in the form of locking terminal posts fastened to the ground on a public thoroughfare, e.g. as described in Document FR-A-2 824 942, in Document FR-A-2 803 935, or in French Patent Application No. 03 07787. It should be noted that, when the automatic article rental system of the invention is applied to articles other than cycles, the locking terminal posts 9 can optionally be different from the above-mentioned terminal posts 9, and can be replaced with other retainer means adapted for retaining the articles prior to rental thereof. Thus, when the articles for rent are small objects, the locking terminal posts 9 can, where applicable, be replaced with boxes or lockers, or with any other automatic dispenser controlled by the CPU 2a, e.g. of the same type as automatic dispensers already used in the prior art for video cassette rental.

In addition, the interactive terminal communicates, via the communications device 2b with an electronic money server 10 (SM), which is generally a remote server, and with a management server 11 (SG) managing the cycle rental, generally also remotely.

Generally, the automatic rental system includes a plurality of interactive terminal posts 2 or the like, each of which controls a plurality of locking stations 9 or of other automatic dispensers, all of the interactive terminals 2 communicating with one or more electronic money servers 10 and with one or more rental management servers 11 which are common to the various terminal posts 2.

The above-mentioned automatic cycle storage system can, for example, operate as follows.

When a user wants to take out a cycle 1 that is in place on one of the locking terminal posts 9, said user can't for example, insert an electronic payment card into the reader 5 of the interactive terminal post 2, and can then input a secret code by means of the keypad 3.

The terminal post 2 then communicates with the electronic money server 10 and requests an authorization to debit an account associated with the payment card (in particular a card account) for a predetermined maximum value. If the code input by the user is correct, the electronic money server 10 sends back a debit authorization, which is valid for a limited period, e.g. 7 days, and which is identified by an authorization identifier, e.g. by a file number.

The interactive terminal post 2 then sends said authorization identifier to the rental management server 11 which stores the following in a memory:

said authorization identifier;

information representing the limited period of validity of the authorization (e.g. date of the start of or of the end of said period); and

where applicable, the maximum value of the authorization (if said value is always the same, it is not stored every time a transaction takes place).

If the user wishes to rent a cycle 1 immediately, said user chooses it by means of the keypad 3 from among the cycles present at the locking stations 9, by being guided by the indications given by the screen 4. In which case, the interactive terminal post 2 indicates to the management server 11 that a cycle is being taken out in a “rental account” corresponding to the authorization identifier that has just been sent to said management server.

Optionally, the user can choose not to rent a cycle immediately.

In both cases, regardless of whether the user rents a cycle, the interactive terminal post 2 prints a ticket 8 and said terminal post writes, preferably on the magnetic stripe 8a of the ticket, an identity code such as the above-mentioned file number. Optionally, the identity code can be different from the file number, in which case the terminal post 2 indicates said code to the management server 11 which stores it in correspondence with the authorization identifier. For example, all or some of the identity code can be already recorded on the magnetic stripe 8a of the ticket, so as to save time when issuing the ticket (the identity code can thus have a fixed header and a variable suffix, e.g. an incremental suffix).

The ticket in question is of the same standardized format as the payment card and its magnetic stripe 8a is placed in the same way of the magnetic stripe 6a of a standard payment card, so that the ticket B can be inserted into the reader 5 and so that its magnetic stripe can be read, as is common practice with car park tickets.

At the same time, the interactive terminal post 2 can optionally communicate to the user a confidential code, or ask the user to choose a confidential code. The confidential code is then transmitted to the management server 11 which stores it in a memory in correspondence with the authorization identifier.

When the above-mentioned user, or another user to whom the initial user has lent his or her ticket 8, subsequently wishes to rent a cycle during said limited period, the user in question merely has to insert the ticket 8 in the reader 5 of an interactive terminal post 2 of the automatic rental system, in which terminal post the identity code is read, and, where applicable, to input the confidential code on the keypad 3.

This data is transmitted to the rental management server 11 which:

verifies that the ticket corresponds to a debit authorization that is still valid and that the authorized maximum amount in the rental account is not exceeded;

where applicable, verifies that the confidential code does indeed correspond to the identity code; and

then authorizes or does not authorize the rental of one or more cycles, as a function of said verification

The user then chooses the cycle that he or she wishes to take out, as explained above, then the ticket is returned to the user, the chosen cycle is unlocked, and the management server 11 takes note that a cycle has been taken out on the rental account corresponding to the authorization identifier.

The rental account is incremented by a certain amount, either when the cycle is rented, the rental then being for a predetermined maximum time, or when the cycle 1 is returned to a locking station 9 of the automatic rental system (at the place from which the cycle was taken out or at some other place).

When the limited period for the debit authorization is close to expiry (e.g. a few hours before the end of the period), and/or when the amount of the rental account reaches a maximum authorized amount (less than the maximum value of the debit authorization), the rental management server 11 communicates with the electronic money server 10 so as to request that a value corresponding to the amount of the rental account be debited (from the account associated with the card),

In addition, if the cycle taken out is not returned to a locking terminal station 9 after a maximum allowable time limit has expired, e.g. 24 hours, the rental management server 11 communicates with the management server 11 for debiting the amount of a predetermined deposit, e g, the maximum value of the debit authorization. In which case, it is also possible to send a warning message to the user prior to making the debit, e.g. by Short Message Service (SMS) or by electronic mail, subject to the user having given a telephone number or an email address during the initial step of creating the ticket 8.

It should be noted that the above-mentioned identity code could optionally be written on the ticket 8 in the form of a bar code or the like, or written on an information medium other than a ticket, optionally readable by a reader other than the payment card reader

Optionally, the identity code could merely be communicated to the user by the screen 4 during the initial debit authorization step, or chosen by the user during that step, in which case said user would merely have to input his or her identity code on the keypad 3 or on some other input interface during subsequent rental operations, without even having to insert any ticket in the interactive terminal post 2.

In another variant, it is possible to ask the user for his or her mobile phone (cellphone) number during the initial debit authorization step, and that number then serves as the identity code. In which case, during each subsequent rental operation, the user uses his or her mobile phone to call a predetermined number corresponding to the rental management server 11, which determines the calling telephone number and thus determines the corresponding debit authorization so as to verify whether or not a further rental operation can still be authorized. If a further rental operation is authorized, the user indicates, e.g. by means of the keypad of his or her phone, a code borne by the interactive terminal post or displayed on the screen 4 thereof, and then the rental operation steps continue as explained above. Each time a rental operation takes place, the user can also be asked for a confidential code as indicated above, the code being input either via the keypad of the mobile phone, or via the keypad of the interactive terminal post.

1. A method of automatically renting bicycles a by means of interactive terminal posts which communicate remotely with at least one rental management server and each of which controls a plurality of locking stations to which the bicycles are locked, said method comprising the following steps:
(a) an initial step consisting in:
reading a payment card;
communicating with an electronic money server for generating a debit authorization for debiting a certain maximum value from an account associated with the payment card, this authorization being valid for a limited period;
allocating an authorization identifier to said authorization; and
storing the authorization identifier in the rental management server;
(b) at least one subsequent rental step taking place during said limited period and consisting in:
a user who wishes to rent a bicycle a indicating at least one identity code associated with said authorization identifier;
the rental management server being used to verify that the identity code indicated by the user corresponds to said authorization identifier stored in said rental management server;
the bicycle rental being authorized or not authorized as a function of said verification;
a rental account in the rental management server being incremented, said rental account corresponding to said authorization identifier; and
(c) a debit step consisting in the rental management server communicating to the electronic money server the authorization identifier and an amount to be debited from said account associated with the payment card, said amount being a function of the rental operations effected, inclusively from said initial step, said amount being no more than said maximum value

2. A method according to claim 1, in which, during the initial step, the identity code is communicated to a user and, during each subsequent rental step, the identity code is input by said user on an input interface

3. A method according to claim 1, in which, during the initial step, the identity code is written on an information medium, and, during each subsequent rental step, the identity code is read automatically from said information medium.

4. A method according to claim 3, in which, during the initial step, a ticket bearing said identity code and constituting said information medium is issued.

5. A method according to claim 4, in which, during the initial step, the identity code is recorded on a magnetic stripe carried by said ticket.

6. A method according to claim 4, in which the code borne by the ticket is written at least in part during the initial step, after the debit authorization.

7. A method according to claim 6, in which the code written on the ticket includes the authorization identifier generated during the initial step.

8. A method according to claim 6, in which the code written on the ticket is pre-written at least in part prior to the initial step, and, during said initial step, a correspondence between the code written on the ticket and the identifier determined during the debit authorization is stored in a memory.

9. A method according to claim 8, in which the code written on the ticket comprises a pre-written portion written before the initial step and a portion written during said initial step.

10. A method according to claim 4, in which during the initial step, a payment card of predetermined format is used, and the ticket presents said predetermined format.

11. A method according to claim 10, in which the payment card presents a magnetic stripe having a predetermined position, the ticket also presents a magnetic stripe having the same position, and the identity code is written on the magnetic stripe of said ticket.

12. A method according to claim 1, in which, during the initial step, a code borne by a mobile phone is recorded as the identity code, and, during each subsequent rental step, the user calls a predetermined number, the calling telephone number is determined, and the authorization identifier corresponding to said identity code is thus determined

13. A method according to claim 1, in which, during each subsequent rental step, when the bicycle is returned to a locking station, said bicycle is locked again to said locking station.

14. A method according to claim 1, in which the debit step is implemented at a time that is predetermined relative to the initial step.

15. A method according to claim 1, in which the debit step is implemented when the cumulative cost of the rental operations that have taken place during said limited period teaches a certain predetermined amount that is no more than said maximum value

16. A method according to claim 1, in which the initial step includes an initial rental step during which, after the debit authorization, at least one bicycle that is locked to a locking station is released, and then, when the bicycle is returned to a locking station, said bicycle is locked to said locking station again.

17. A method according to claim 1, in which, each time a rental operation takes place, the value of a sum owed by the user of the payment card is incremented.

18. A method according to claim 1, in which each bicycle is identified at least when it is taken out and when it is returned, and when a bicycle taken out is not identified as a bicycle returned at the end of a certain predetermined time limit, the debit step is preformed immediately, and a deposit is debited from said account

19. A method according to claim 1, in which, during the initial step, a confidential code is determined, and, during each subsequent rental step, the rental is authorized only after verifying that the confidential code is known by the user requesting the rental.

20. A method according to claim 1, in which provision is made for the confidential code to be chosen by the user during the initial step.

21. A method according to claim 1, in which, during the initial step, an address given by the user is stored in a memory, and communication is established with the user via said address if a bicycle taken out using the identity code of said user is not returned within a predetermined time limit.

22. A system for implementing a method according to claim 1, said system comprising:
interactive terminal posts which communicate remotely with at least one rental management server, and each of which controls a plurality of locking stations to which the bicycles are locked;
means for reading a payment card;
means for communicating with an electronic money server for obtaining a debit authorization for debiting a certain maximum value from an account associated with the payment card, said authorization being valid for a limited period, and said authorization being identified by an authorization identifier;
means for storing said authorization identifier in the rental management server; and
means for acting by communicating with the rental management server to determine whether an identity code indicated by a user corresponds to said authorization identifier, so a to authorize or not authorize the desired rental of a bicycle as a function of said verification, and so as to increment, each time bicycle rental is effected, a rental account in the rental management server, said rental account corresponding to said authorization identifier;
the rental management server being adapted to communicate to the electronic money server the authorization identifier and an amount to be debited from said account associated with the payment card, said amount being a function of the rental operations effected and being no mote than said maximum value.
